(19) United States
(12) Patent Application Publication
(10) Pub. No.: US 2023/0266450 A1
(43) Pub. Date: Aug. 24, 2023

(54) System and Method for Solid-State LiDAR with Adaptive Blooming Correction

(71) Applicant: OPSYS Tech Ltd., Holon (IL)

(72) Inventors: Niv Maayan, Gealiya (IL); Amit Fridman, Yehud (IL); Mark J. Donovan, Mountain View, CA (US); Sara Israeli, Be'er Ya'akov (IL); Gil Aharon Cohen, Ashdod (IL); Yaacov Kagan, Jerusalem (IL)

(73) Assignee: OPSYS Tech Ltd., Holon (IL)

(21) Appl. No.: 18/167,847

(22) Filed: Feb. 11, 2023

Related U.S. Application Data
(60) Provisional application No. 63/312,356, filed on Feb. 21, 2022.

(51) Int. Cl. G01S 7/497; G01S 17/894; G01S 7/4863

(52) U.S. Cl. CPC G01S 7/497; G01S 17/894; G01S 7/4863

(57) ABSTRACT

A method of LIDAR includes configuring a laser array such that each laser generates an optical beam having a FOV and intensity that illuminates a ROI and configuring a detector array such that each detector receives light from a detector FOV in the ROI. The laser array is energized and light is received at the detector array from the illuminated ROI. The received light is processed for select ones of the detectors with standard parameters to determine TOF data for the select ones of detectors to generate an image of an object in the ROI. The TOF data for the select detectors is analyzed to determine if a blooming criterion is met and, if so, the laser is re-energized. Light is then received at the detector array from the illuminated ROI and processed with parameters to determine TOF and intensity data that compensate for the blooming.

### CROSS-REFERENCE TO RELATED APPLICATION

The present application is non-provisional of U.S. Provisional Patent Application No. 63/312,356 entitled “System and Method for Solid-State LiDAR with Adaptive Blooming Correction”, filed on Feb. 21, 2022. The entire contents of U.S. Provisional Patent Application No. 63/312,356 are herein incorporated by reference.

The section headings used herein are for organizational purposes only and should not be construed as limiting the subject matter described in the present application in any way.

### INTRODUCTION

Autonomous, self-driving, and semi-autonomous automobiles use a combination of different sensors and technologies such as radar, image-recognition cameras, and sonar for detection and location of surrounding objects. These sensors enable a host of improvements in driver safety including collision warning, automatic-emergency braking, lane-departure warning, lane-keeping assistance, adaptive cruise control, and piloted driving. Among these sensor technologies, light detection and ranging (LiDAR) systems take a critical role, enabling real-time, high-resolution 3D mapping of the surrounding environment.

LiDAR systems need to be able to perform under a variety of conditions, including situations that include combinations of near and far distances of objects and various weather and ambient lighting conditions. It is important that the LiDAR be able to provide accurate object size information in these and other conditions. An adaptive LiDAR system is needed that can advantageously provide improved image and object identification properties as conditions change and evolve.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1A illustrates a schematic diagram of a known solid-state LiDAR system.

FIG. 1B illustrates a two-dimensional projection of the system Field-of-View (FOV) of the LiDAR system of FIG. 1A.

FIG. 2A illustrates a two-dimensional projection of a LiDAR system laser FOV and detector FOV for an embodiment of a LiDAR system of the present teaching.

FIG. 2B indicates the detectors corresponding to a single laser FOV in a two-dimensional projection of the LiDAR system FOVs of FIG. 2A.

FIG. 2C indicates the detector regions affected by blooming in the LiDAR system of FIG. 2A.

FIG. 3 illustrates a block diagram of an embodiment of an adaptive blooming identification and correction LiDAR system that includes a separate transmitter and receiver system connected to a host processor of the present teaching.

FIG. 4 illustrates a process flow chart for an embodiment of an adaptive blooming identification and correction LiDAR System of the present teaching.

FIG. 5 illustrates a process flow chart for analysis of a region of interest to determine whether a blooming mode or a standard operating mode should be used for an embodiment of the adaptive LiDAR system of the present teaching.

FIG. 6 illustrates a process flow chart for blooming mode for an embodiment of the adaptive LiDAR system of the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

LiDAR systems for autonomous cars must be able to perform under a variety of driving scenarios. For example, accurate range and image data that can be in the form of a three-dimensional point cloud should be obtained for a reflective traffic cone a few meters away, as well as a vehicle tire lying in the roadway, one hundred fifty meters distant. From an optical perspective, these two scenarios present substantially different characteristics, as the received optical signal amplitude from each object will vary by several orders of magnitude. The traffic cone will result in a very strong optical return, while the distant tire will produce a weak signal. The ratio of the largest to the smallest optical signal that can be reliably received by the LiDAR system, is sometimes referred to as the receiver dynamic range.

Direct time-of-flight (TOF) LiDAR systems using single-photon avalanche diode (SPAD) detectors are one type of LiDAR system that exhibits a high dynamic range. SPAD devices are sensitive to single photons (lowest possible optical power) but are not damaged by high optical powers. Damage from high optical power can occur, for example, with conventional avalanche photodiodes (APD). As a result of the high detector dynamic range, whether a SPAD detector receives a single photon, or the full power of the laser transmitter reflected back, the SPAD will continue to function. Commonly SPADs are formed in two-dimensional arrays, and each SPAD detector in the SPAD array of detectors is referred to as a pixel.

One common configuration for LiDAR systems is to use a SPAD focal-plane array made up of groups of pixels, where each group has a common signal output, also referred to as “multi-pixel”. In this configuration, each multi-pixel incorporates several individual SPAD pixels grouped together. A multi-pixel has a single combined received signal output from all of the pixels in the multi-pixel group and this combined signal provides a measure of optical intensity over some optical power range which is not provided in a single pixel output. A SPAD array without multi-pixel configuration would produce a binary image, because an individual SPAD pixel is essentially a digital device with two stable output states. That is, a SPAD pixel either generates a very low quiescent current, or generates a maximum current when operating at saturation because a received photon has triggered an avalanche. The transition between these two states is fast enough to essentially provide a digital output.

In contrast, a 2D SPAD array using a “multi-pixel” can be used to generate a gray scale intensity image which provides additional information about the scene as compared to a binary image. In a multi-pixel, not all SPAD will be at saturation across some power levels, giving a stepwise measure of intensity. This allows, for instance, the ability to determine reflectance of an object, and to differentiate lane markings or read signs in some conditions. Said another way, in a multi-pixel configuration, it is possible to determine information about the intensity of a return, in addition to the time-of-flight of the return.

However, at a high enough received optical power level, every SPAD pixel in a multi-pixel will simultaneously saturate. In this limiting case, range accuracy from determination of time-of-flight is largely maintained, but the imaging performance is degraded by a loss of contrast. As a result, at high input powers, even for a multi-pixel SPAD, the image can become more binary in nature.

Another issue besides loss of contrast, is a phenomenon referred to as “blooming”, which is characterized by an image of an object being larger than the true object. Thus, a three-dimensional point cloud representation of the object is larger than the true object. As an example, a road sign that uses a retro-reflector material presents a typical case of an object with high reflectivity, that often results in blooming with LiDAR systems. In the presence of blooming, reflective road signs can appear larger than normal, or lose their shape, making it difficult, for instance, to distinguish a stop-sign from a speed limit sign.

In any imaging lens system, light from an infinitely small point-source (such as a star) will form a spot on the focal plane detector array with some finite radius and distribution of optical energy. Physical properties of light and limits of any real imaging system do not allow for a point-source to result in an infinitely small, imaged spot on the focal plane array. If the image of a point-source like a star is brought to its sharpest focus by a lens system, the physics of diffraction and aberration/distortion inherent in non-perfect lenses, result in the optical energy being distributed over a pixel area of some size.

In optics, the term encircled energy (EE) refers to a measure of concentration of optical energy. Encircled energy is equivalent to the amount of energy within the imaged spot at a given radius, often reported in microns. Typically, one number is reported for EE corresponding to the radius at which 80% of the optical energy is encircled. For typical imaging lenses used in LiDAR systems considered here, the EE is in the range of 5 to 40 microns. The EE radius is larger than the size of a typical individual SPAD pixel in the focal plane detector array, which is ˜10 microns for current generation technology. Also, it is important to note that the EE number corresponds only to 80% of the energy and thus there will be some optical power at larger radii, which can be considered as one type of stray light within a LiDAR optical system.

For a LiDAR system using a SPAD detector array, which is sensitive enough to detect single photons, the physics which result in light spreading as characterized by the encircled energy, causes blooming. A highly reflective object which results in a large optical received power will correspondingly have larger amounts of stray light at extended radii than a same size object of lower reflectivity. If the stray light is high enough, a larger area of pixels within the detector will receive enough light to trigger an avalanche and result in a TOF detection. This is undesirable because the highly reflective object causes the image to appear larger than the actual object. That is, a processed receive image, which can be a three-dimensional point cloud representation, from a highly reflective object that causes blooming will be larger than the true image size that would be derived from a three-dimensional point cloud representation from the object with no blooming. It should be understood that a three-dimensional point cloud representation from the object with no blooming is considered to be a true three-dimensional point cloud representation of the object.

Conventional Flash LiDAR systems employ an emission source that emits laser light over a wide FOV. Some Flash LiDAR systems are solid-state. Flash LiDAR systems can illuminate the entire scene with a single illumination event. Thus, a Flash LiDAR system that uses a SPAD array, when the entire scene is illuminated at once, can have a significant blooming impact, with images of highly-reflective objects appearing to much larger than actual size, at the limit potentially filling the total FOV.

A conventional Flash LiDAR system using a SPAD array, where the whole field-of-view (FOV) is illuminated at one time, could be completely blinded in some cases by blooming. Significant blooming, where every pixel in the array is affected by stray light, could cause the system to report an object as large as the complete FOV, when in reality the object could be a small, highly reflective object like a taillight assembly on a car, or a reflective traffic cone. For autonomous vehicles making use of LiDAR, it is highly undesirable for an object to appear larger than actual as it may result in the vehicle making a path adjustment larger than necessary, or even unnecessary braking or stopping, depending on the range and reported image size of the object as derived from a three-dimensional point cloud representation of that object. In any event, there is a potential for an unsafe condition.

It is highly desirable for a LiDAR system that uses highly sensitive detector arrays to have the ability to determine that optical blooming has occurred, and also to adaptively mitigate the impact of blooming on the reported image and TOF data.

The pulsed TOF LiDAR system of the present teaching uses collimated transmitter laser beams with an illuminated laser FOV being created for each laser's optical beam. The laser FOVs are much smaller in size compared to a conventional Flash LiDAR system. In addition, the pulsed TOF LiDAR systems of the present teaching can use pulse averaging and/or pulse histogramming of multiple received laser pulses to improve Signal-to-Noise Ratio (SNR), which further improves range and performance. Also, these LiDAR systems can employ a very-high single-pulse frame rate, which can be well above 100 Hz.

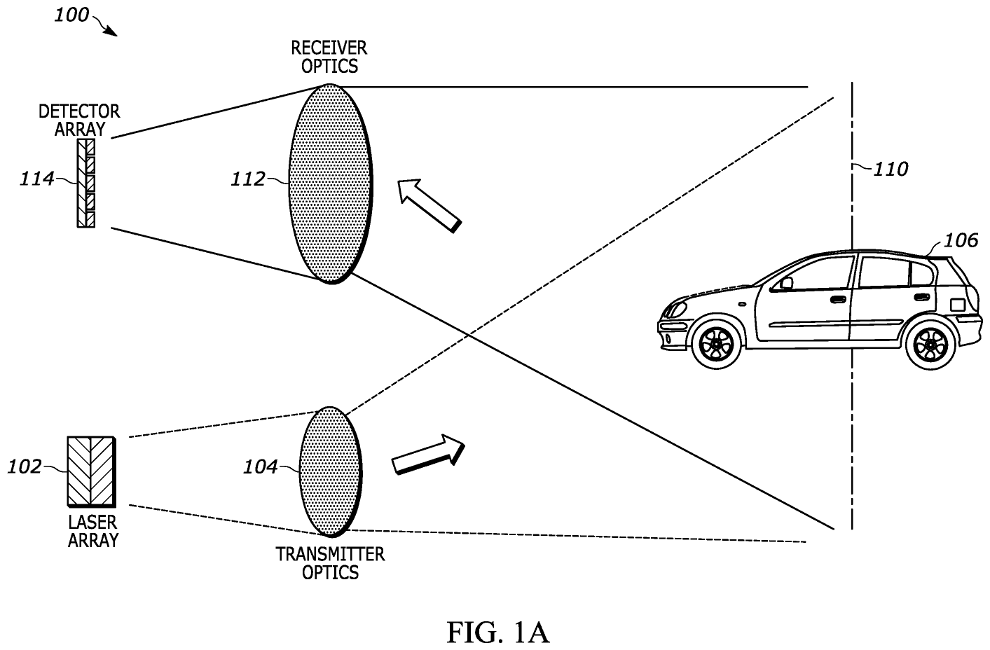

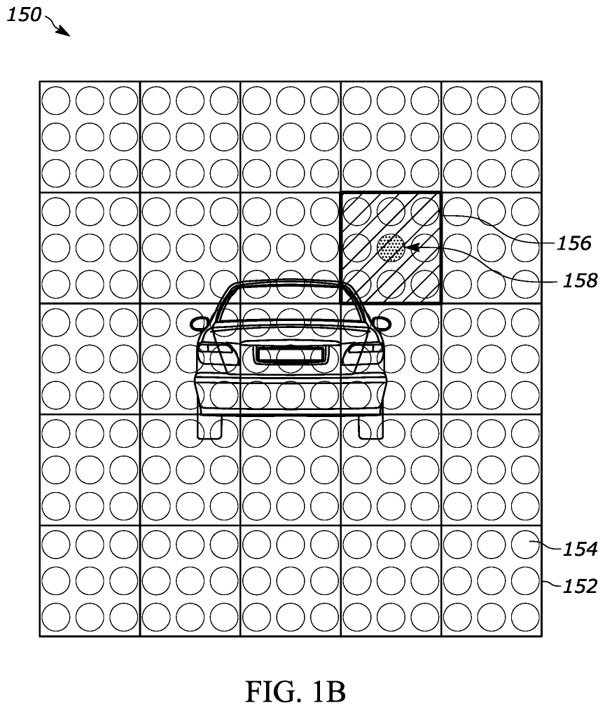

FIG. 1A illustrates a schematic diagram of a known solid-state LiDAR system 100. The system illustrated in FIG. 1A does not employ a flash transmitter that illuminates the full system field-of-view all at once. A laser array 102 generates various patterns of optical beams. An optical beam is emitted from an emitter in the array 102 when that emitter is activated by a control pulse. One or more emitters are activated, sometimes according to a particular sequence. The optical beams from the lasers in the laser array 102 propagate though common transmitter optics 104 that project the optical beams to the target 106 at a target plane 110. The target 106 in this particular example is an automobile 106, but it is understood that the target can be any object.

Portions of the light from the incident optical beams are reflected by the target 106. These portions of reflected optical beams share the receiver optics 112. A detector array 114 receives the reflected light that is projected by the receiver optics 112. In various embodiments, the detector array 114 is solid-state with no moving parts. The detector array 114 typically has a fewer number of individual detector elements than the transmitter array 102 has individual lasers. Each detector in the detector array 114 has a detector FOV at the target plane 110 based on its position, size and the configuration of the receive optics 112.

The measurement resolution of the LiDAR system 100 is not determined by the size of the detector elements in the detector array 114, but instead is determined by the number of lasers in the transmitter array 102 and the collimation of the individual optical beams. In other words, the resolution is limited by a field-of-view of each optical beam. A processor (not shown) in the LiDAR system 100 performs a time-of-flight (TOF) measurement that determines a distance to the target 106 from optical beams transmitted by the laser array 102 that are detected at the detector array 114.

One feature of LiDAR systems according to the present teaching is that individual lasers and/or groups of lasers in the transmitter array 102 can be individually controlled. Each individual emitter in the transmitter array can be fired independently, with the optical beam emitted by each laser emitter corresponding to a 3D projection angle subtending only a portion of the total system field-of-view. One example of such a LiDAR system is described in U.S. Patent Publication No. 2017/0307736 A1, which is assigned to the present assignee. The entire contents of U.S. Patent Publication No. 2017/0307736 A1 are incorporated herein by reference.

Another feature of LiDAR systems according to the present teaching is that detectors and/or groups of detectors in the detector array 114 can also be individually controlled. This independent control over the individual lasers and/or groups of lasers in the transmitter array 102 and over the detectors and/or groups of detectors in the detector array 114 provide for various desirable operating features including control of the system field-of-view, optical power levels, and scanning pattern. It is also possible in some embodiments to change the laser FOV, making it larger or smaller or moving the relative position in the detector FOV at the target plane 110 by adjusting the relative positions of the transmit optics 104 and laser array 104.

FIG. 1B illustrates a two-dimensional projection of the system field-of-view 150 of the LiDAR system described in connection with FIG. 1A. Referring to both FIGS. 1A and 1B, a field-of-view of an individual detector in the detector array is represented by a small square 152. An illuminated measurement point associated with an individual emitter in the transmitter laser array 102 is illustrated by a circle 154. A single 3D measurement point in the overall field-of-view of the LiDAR system of FIG. 1A is shown as particular dark circle 158, which corresponds to a specific individual laser in the laser array. It can be further seen in FIG. 1B that this measurement point falls within an individual detector where the field-of-view of that individual detector in the detector array 114 has been shown in the square 156 with a cross-hatch pattern for identification. This figure illustrates that the 3D resolution of some embodiments of the LiDAR system are determined by the number of lasers, as each laser corresponds to a specific angular projection angle that gives rise to the size of the circles 154 at the target range, and the relative size of the circles 154 and the squares 152 that represent the field-of-view of an individual detector element.

Thus, desired fields-of-views can be established by controlling particular individual or groups of lasers in a transmitter array and/or controlling individual or groups of detectors in a receive array. Various system fields-of-view can be established using different relative fields-of-view for individual or groups of emitters and/or individual or groups of detectors. The fields-of-view can be established so as to produce particular and/or combinations of performance metrics. These performance metrics include, for example, improved signal-to-noise ratio, longer range or controlled range, eye safe operation power levels, and lesser or greater controllable resolutions. Importantly, these performance metrics can be modified during operation to optimize the LiDAR system performance.

LiDAR systems according to the present teaching use an array drive control system that is able to provide selective control of particular laser devices in an array of laser devices in order to illuminate a target according to a desired pattern. Also, LiDAR systems according to the present teaching can use an array of detectors that generate detector signals that can be independently processed. Consequently, a feature of the LiDAR systems of present teaching is the ability to provide a variety of operating capabilities from a LiDAR system exclusively with electronic, non-mechanical or non-moving parts that include a fixed array of emitters and a fixed array of detectors with both the transmit and receive optical beams projected using shared transmit and receive optics. Such a LiDAR system configuration can result in a flexible system that is also compact, reliable, and relatively low cost.

LiDAR systems of the present teaching also utilize a laser array, transmitter optics, receiver optics and detector array as described in connection with the known system shown in FIG. 1A. However, these elements in the present teaching are chosen and configured such that the two-dimensional projection of the system field-of-view is different. One feature of the present teaching is that the elements are configured such that the field-of-view of a single emitter is larger than a field-of-view of a single detector.

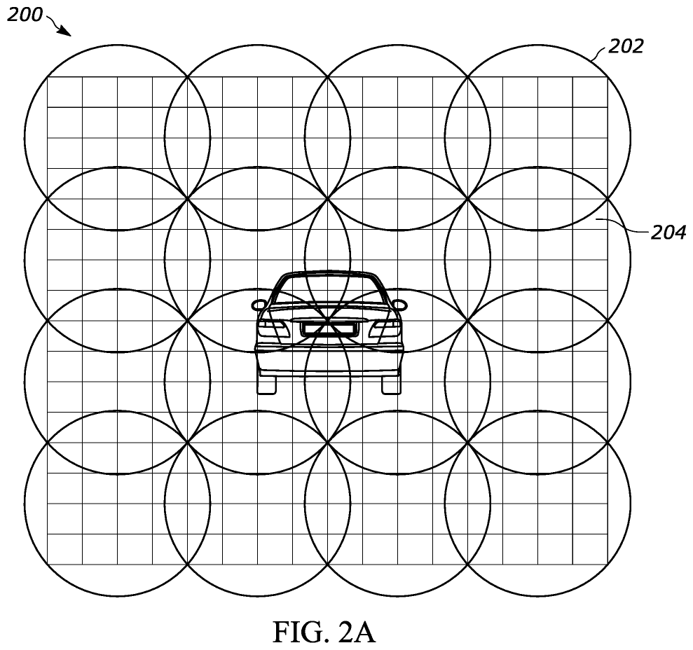

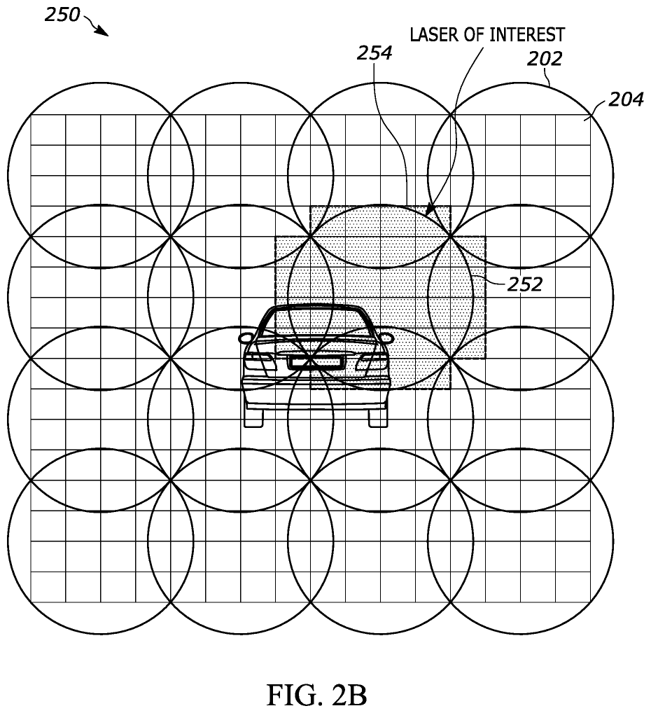

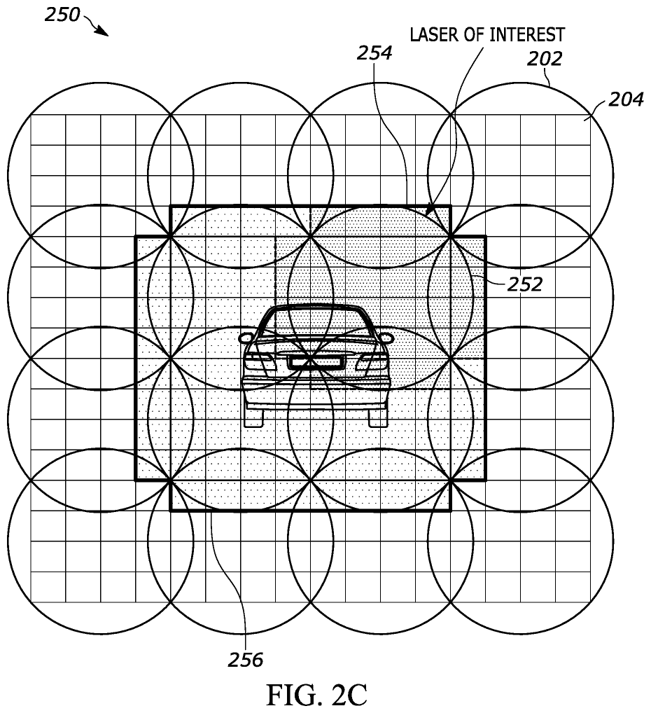

FIG. 2A illustrates a two-dimensional projection of a LiDAR system FOV 200 including laser FOV 202 and detector FOV 204 for an embodiment of a LiDAR system of the present teaching. The system described in FIG. 2A is a projection of a LiDAR system with a laser array and transmit optics as described in connection with LiDAR systems of FIGS. 1A and 1B. However, the elements are spaced and arranged to produce the LiDAR system FOV 200 as shown. Specifically, an array of lasers produces an array of beams with circular FOV's with a particular size, represented by the sixteen circles, laser FOV 202, as shown. Various embodiments generate various shapes of laser beam FOV 202 depending on the emitter and projection optics.

The LiDAR system FOV 200 shown in FIG. 2A is generated by a 4×4 (16) laser array. The divergence/collimation of the laser has been chosen so that there is only enough overlap such that there are no “gaps” in the field-of-view. That is, the laser FOVs 202 overlap and form a 4×4 array. An array of detectors provides an array of square detector FOV's 204 with a particular size, represented by 256 squares. The individual detector FOV 204 region represented by square is sometimes referred to as a pixel. It can be seen that there are 16×16 (256) detectors with practically continuous coverage across the array. It should be understood that the number of lasers and detectors, as well as the particular size and shape of the FOV of the emitter and detector elements, has been chosen to illustrate features of the present teaching, and are not necessarily representative of an actual system.

In the embodiment of the LiDAR system of FIG. 2A, the number of detectors (256) exceeds the number of lasers (16). This embodiment represents an important use case for LiDAR systems according to the present teaching in which the FOV of a laser emitter FOV 202, which is represented by a circle, covers the FOV of a number of detector FOVs 204, which is represented by squares.

Various detector technologies can be used to construct the detector array for the LiDAR systems according to the present teaching. For example, Single Photon Avalanche Diode Detector (SPAD) arrays, Avalanche Photodetector (APD) arrays, and Silicon Photomultiplier Arrays (SPAs) can be used. The detector size not only sets the resolution by setting the FOV of a single detector, but also relates to the speed and detection sensitivity of each device. State-of-the-art, two-dimensional arrays of detectors for LiDAR are already approaching the resolution of VGA cameras, and are expected to follow a trend of increasing pixel density similar to that seen with CMOS camera technology. Thus, smaller and smaller sizes of the detector FOV 204 represented by the squares are expected to be realized over time. For example, an APD array with 264,000 pixels (688(H)×384(V)) was recently reported in the literature “A 250 m Direct Time-of-Flight Ranging System Based on a Synthesis of Sub-Ranging Images and a Vertical Avalanche Photo-Diodes (VAPD) CMOS Image Sensor”, Sensors 2018, 18, 3642.

FIG. 2B indicates the detectors corresponding to a single laser FOV in a two-dimensional projection of the LiDAR system FOVs 250 of FIG. 2A. Similar to the LiDAR system FOV 200 shown in FIG. 2A, a single laser FOV 202 is represented by a circle, and a single detector FOV 204 is represented by a square. A laser of interest is energized by a controller to illuminate a FOV 252 represented by a particular circle. The controller generates a bias signal that energizes the desired laser or lasers at the desired time. The detector FOVs that overlap with at least some portion of the laser beam FOV represented by the circle are within the shaded region 254 in the system FOV. In this particular configuration, a detector region 254 that includes thirty-two individual detector FOVs is realized for a single laser beam FOV 252. Each detector FOV in the detector region 254 has a detector FOV associated with a small square within the region 254. Note that in various embodiments, the detector region 254 is not necessarily square or rectangular. The shape of the region 254 depends on detector shape and the laser beam profile, either of which can be any shape (circular, square, or other).

A controller selects a set of one or more detectors in region 254 that fall within the laser beam FOV 252 of the selected laser. Signals from the selected set of detectors are detected simultaneously and the detected signal provided to the controller and then processed to generate one or more measurement signal. The LiDAR system could measure the TOF independently and simultaneously for all detectors in the selected set or alternatively the system could combine the signal output from selected detectors to form a single measurement. Also, each detector could be either a single pixel or a multi-pixel, as previously described. For long-range operation, including operation at the longest specified range of the LiDAR system, the number of pixels (i.e. individual detectors) used to generate the measurement pulse might be chosen to maximize the SNR at the expense of resolution. For example, the best SNR might correspond to a measurement made by summing or combining in some fashion the received signal from all the detectors in region 254 shown highlighted in FIG. 2B. That is, multiple contiguous detectors that fall within the laser FOV 252 of the selected laser might be chosen. In some embodiments, only those detectors that are fully illuminated by the light in the laser FOV 252 of the laser are chosen. That way, noise from detectors that are not fully illuminated is not accumulated. Alternatively, a smaller subset of detectors might be chosen. For instance, in some configurations according to the present teaching, the power from the laser is not distributed uniformly across the beam profile. In these configurations, a subset of detectors that matches the profile of the beam can be used so the detectors that receive a higher intensity of the incident light are selected.

Blooming can occur with the LiDAR system described by FIGS. 2A and 2B. For example, in FIG. 2B, the upper half and corner of the car are illuminated by the laser FOV 252. The headlight assembly of a car at some angles is highly reflective, since it acts as a parabolic mirror, producing a very high optical power return to the LiDAR system. In this situation, blooming can occur, and all detectors that correspond to laser FOV 252 could receive a signal high enough to trigger an avalanche response. The corresponding measured image would look like the complete shaded area for all detectors in the region 254, if all detectors were driven to near saturation. All of the lasers in the system that intersect with one of the two headlights could exhibit blooming. In the worst case, the size of the car would correspond to all detectors for the four central lasers, each of which overlaps with at one headlight assembly.

FIG. 2C indicates the detector regions affected by blooming in the LiDAR system of FIG. 2A. A depiction of worst-case blooming image is shown in FIG. 2C where all detectors corresponding to the four central laser FOVs are shown in a shaded region 256. The apparent size of the car in the image is now >6× larger in area then the actual size of the car. An autonomous car which received such information, would need to steer a much wider path then necessary to avoid the oncoming car. It might also not be clear that the reported object is a vehicle given the much larger than true size, which could cause additional uncertainty for the path planning and response.

FIG. 2C also shows that the blooming is limited to the regions of detectors associated with the lasers that illuminate a headlight. The size of the blooming is limited by the size of the laser for this type of LiDAR system. In general, the smaller the physical size of any individual laser, the smaller the corresponding maximum blooming associated with that laser. A reduction in maximum worst-case blooming compared to that seen in FIG. 2C can be done by increasing the number of individual lasers, and also by reducing size and overlap of the lasers by changing laser FOV size and/or shape. For instance, if the lasers were not circular but instead rectangular without overlap, then the blooming would only correspond to two lasers instead of four lasers as shown in the shaded region 256 of FIG. 2C. Also, shrinking the area of the laser FOV by one-half, which would require 64 lasers instead of 16, would shrink the bloomed area significantly. It can be understood that a LiDAR system using highly collimated laser beams with small individual FOV will be less susceptible to blooming than a Flash LiDAR system where a large portion of the overall FOV is illuminated simultaneously. Of course, cost and complexity can increase with the number of lasers the system uses. Instead of, or in addition to increasing the number of lasers, it can be preferred if the system can adapt in some fashion to detect and reduce the blooming.

LiDAR systems according to the present teaching have the capability of determining that blooming is potentially occurring and can then take actions to adapt the system parameters to reduce the impact of blooming on the reported image and TOF data as can be based on the three-dimensional point cloud representation. LiDAR systems of the present teaching implement a set of decision criteria to determine whether blooming is potentially occurring.

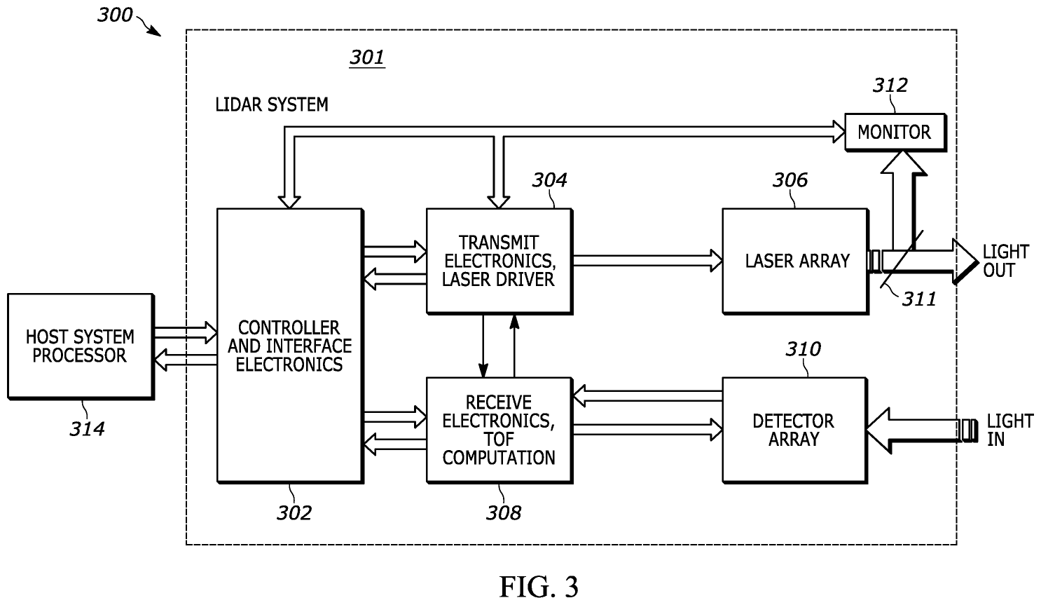

FIG. 3 illustrates a block diagram of an embodiment of an Adaptive Blooming Correction (ABC) LiDAR system 300 that includes a transmitter and receiver system connected to a host processor according to the present teaching. The LiDAR system 300 has six main components: (1) controller and interface electronics 302; (2) transmit electronics including the laser driver 304; (3) the laser array 306; (4) receive and time-of-flight and intensity computation electronics 308; (5) detector array 310; and (6) in some embodiments an optical monitor 312 and a splitter 311 that provides some of the transmit light to the monitor 312.

The LiDAR system controller and interface electronics 302 controls the overall function of the LiDAR system and provides the digital communication to the host system processor 314. The transmit electronics 304 controls the operation of the laser array 306 and, in some embodiments, sets the pattern and/or power of laser firing of individual elements in the array 306.

The receive and time-of-flight computation electronics 308 receives the electrical detection signals from the detector array 310 and then processes these electrical detection signals to compute the range distance through time-of-flight calculations. Intensity information can also be processed. The receive and time-of-flight computation electronics 308 can also control the pixels of the detector array 310 in order to select subsets of pixels that are used for a particular measurement. The intensity of the return signal is also computed in the electronics 308. In some embodiments, the receive and time-of-flight computation electronics 308 determines if return signals from a region of interest at a target plane are indicative of blooming occurring.

In some embodiments, the controller and interface electronics 308 determine if the return signals from a region of interest are indicative of blooming. Also in some embodiments, the host system processor 314 determines if the return signals from a region of interest are indicative of blooming. In some embodiments, the transmit controller 304 controls pulse parameters, such as the pulse amplitude, the pulse width, and/or the pulse delay.

It should be understood that the block diagram of the LiDAR system 300 of FIG. 3 illustrates connections between components, and is not intended to restrict the physical structure in any way. The various elements of the system can be physically located in various positions depending on the embodiment. In addition, the elements can be distributed in various physical configurations depending on the embodiment. Furthermore, the block diagram of the LiDAR system 300 is not intended to limit which specific electronic component is used to perform the adaptive blooming correction, nor is it intended to limit how many electronic components are used to perform the adaptive blooming correction.

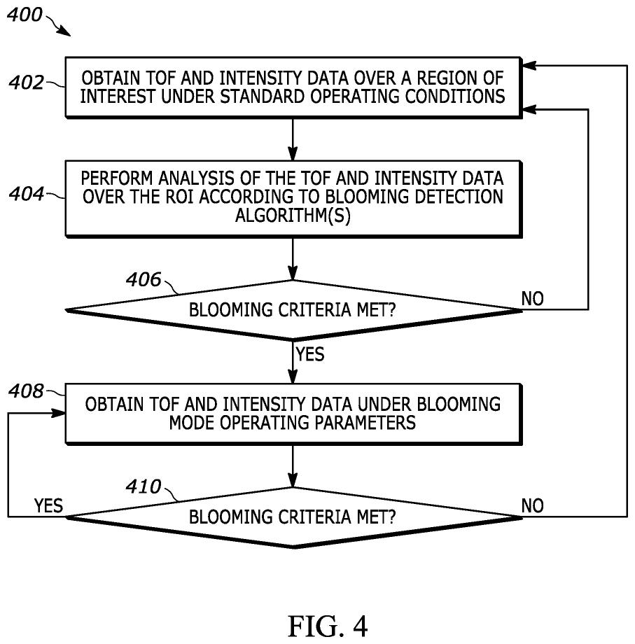

FIG. 4 illustrates a process flow chart 400 for an embodiment of an adaptive blooming identification and correction LiDAR system of the present teaching. The process flow chart 400 describes the overall process steps involved in an embodiment of the adaptive blooming correction process. The LiDAR system described in connection with the process flow chart 400 has a default set of standard operating conditions, including standard parameters used in processing TOF and intensity data for subsequent reporting to the host system processor, under which it will normally operate. In a first step 402, the LiDAR system obtains the TOF and intensity data over a region of interest using standard parameters. The region of interest could be, for example, a portion of the FOV, or the full FOV, or a portion of a frame, or the full frame.

In a second step 404, the system performs an analysis of at least a portion of the obtained TOF, intensity, and/or return pulse characteristic data in order to determine a blooming condition. In some embodiments, in the second step 404, the system performs an analysis of the TOF and intensity data contained in the Region of Interest (ROI) and makes an estimate of whether blooming is occurring or not. The estimate could be a probability, or some other metric, which correlates to the occurrence of blooming. The system then compares the estimate to some blooming criteria which is either determined at the time the system is manufactured or could be adaptively determined during system operation. In a decision step three 406, the system determines if the blooming is occurring based on whether the blooming criteria are met. If the blooming occurrence criteria is not met, the system returns to step one 402, and continues to operate under the standard operating conditions. If the blooming criteria is met, the system will proceed to step four 408, which changes operation to use blooming parameters.

In some embodiments, in step four 408, the system changes operating modes to account for the possibility that blooming is occurring and reports received TOF, intensity, and/or return pulse characteristic data that is processed using blooming mode parameters. In the process flow chart 400, the operating mode is referred to as “blooming mode”. During blooming mode operation, the operating parameters of the system are different from the standard operating parameters. For any region of interest during blooming mode operation, the system performs an analysis of the TOF and intensity data contained in the ROI and makes an estimate of whether blooming is occurring or not in a decision step five 410. If the blooming occurrence criteria is not met, the system will switch back to the standard operating conditions returning to step one 402. If the blooming occurrence criteria is met, the system will continue to operate under blooming mode operating parameters by returning to step four 408.

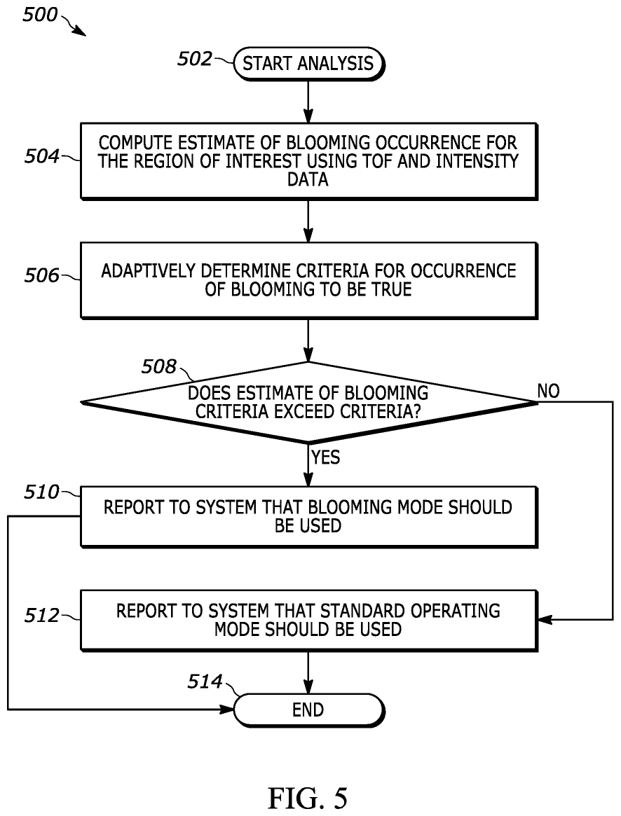

FIG. 5 illustrates a process flow chart 500 for analysis of a region of interest to determine whether a blooming mode or a standard operating mode should be used for an embodiment of the adaptive LiDAR system of the present teaching. More specifically, the process flow chart 500 illustrates method steps of embodiment of the analysis that is carried out on the TOF, intensity, and/or return pulse characteristic data from a region of interest to determine if the operating mode used should be blooming mode or standard mode. For example, the steps in the process flow chart 500 can be used in steps 406 and/or 410 of the process flow 400 described in connection with the process flow chart of FIG. 4. In these embodiments, the transition to steps 406, 410 initiates an analysis start 502. This start 502 transitions to the first step 504 that computes a set of estimates for the occurrence of blooming using the method described herein. The second step 506, which is optional, is to adaptively compute criteria against which the set of estimates from step 504 is applied. In some methods according to the present teaching, the criteria of the second step 506 may need to be determined adaptively because of the wide set of operating conditions under which a LiDAR system operates. For instance, a different criterion might be used in the case of low ambient light (night-time conditions) versus the case of high ambient light (bright sun conditions).

The third step 508 is a decision step to compare the blooming occurrence set of estimates to the criterion. If the criterion is met, the analysis algorithm reports to the system that blooming mode should be used 510. If the criterion is not met, the analysis algorithm reports to the system that standard operating mode should be used 512. The analysis is then ended. For example, for the embodiment of process 400 of FIG. 4, the use blooming mode report 510 would cause transition to step four 408 and the use standard mode report 512 would cause transition to step one 402.

A first set of criteria can be inferred from the description associated with FIG. 2B. In this LiDAR system FOV 250, there is a known mapping of the region of detectors 254 to the laser 252. One possible set of criteria for blooming occurring is that all detectors in the region 254 are reporting similar TOF, and the received signal from the detectors is either saturated or close to saturated in intensity. Also, instead of all the detectors in the region needing to have similar TOF and near saturated intensity, it could also be a defined subset of the detectors as well. In some situations, it may be important to further extend the number of detectors to more than the region 254. If the criteria for similar TOF at near-saturated intensity is met across any defined region of the image, then the system would assume that blooming is possibly occurring and perform some function or functions to adapt to the blooming.

One common boundary or edge condition is the situation when a LiDAR system is looking at a “wall”, such that the true image is the same TOF for all detectors looking at the wall, and the wall could be a “white” wall that is reflective enough to lead to near saturation for all detectors. Thus, in this condition, it cannot be known with 100% confidence that blooming has definitely occurred, only that there is a strong possibility. Additional actions, or adaptations, are necessary by the LiDAR system to confirm the blooming and also to determine the extent of the blooming to the degree that this is possible under such conditions. Besides TOF and intensity, other criterion, such as ones based on the pulse width of the received signal between detectors within any defined region, can also be applied.

Some embodiments of the adaptive blooming LiDAR systems of the present teaching use a blooming mode of operation where more than one set of system parameters is being employed. Each set of system parameters could be a fixed set, or in various embodiments, one or more sets of parameters could be determined adaptively. The different sets of system parameters used by the LiDAR system could be for multiple performance improvements, including range, resolution, frame rate, intensity, reflectance measurement, stray light correction, and blooming correction among other factors.

For example, in one simple embodiment, a second set of system parameters for blooming mode are used that reduce the laser output power, or energized laser optical transmit power, used for measuring the FOV. In this example, the first set of system parameters would have a higher optical power that enables the longest range for the system. A second set of parameters would lower the optical power so that, in the closer ranges, there was less possibility of saturation of the detector. It should be understood that the sets of system parameters do not need to be used on equal basis. The second or additional sets of system parameters could be used in only some small percentage of the time. A lower optical power set of system parameters would allow, for instance, less saturation of the intensity image at closer range, thereby allowing for better identification of items like lane markings or text on signs. The intensity, TOF, and/or pulse characteristic data from the second set of system parameters could be compared to the same data from the first set of performance parameters, and areas of significant difference could be identified as possible areas where blooming was occurring.

The above descriptions are illustrative of possible operating modes for which more than one set of system parameters is being used. Another operating mode might involve adaptive changes to the averaging or histogramming parameters used to process the TOF and/or intensity data. One feature of the methods and apparatus of the present teaching is that the system and method are configured so that two (or more) sets of data that are regularly available can be compared against each other. As such, differences in intensity, TOF, and/or pulse width for those two sets of data could indicate potential blooming, from which the system would then take additional actions to confirm and correct the blooming impacts. The two sets of data could come from, for example, two different detector FOVs in the region of interest, two different laser FOVs in the region of interest, two different optical transmit powers of an energized laser in a single laser FOV in the region of interest, as well as various combinations of these and other parameters.

Once the LiDAR system has determined that blooming is possible, then various algorithms can be used to confirm the blooming and reduce the blooming impact on the reported data. One class of algorithms depends on obtaining measurements with a lower optical power illuminating the detectors. By lowering the illumination so that the detectors are not in saturation, the blooming effect is reduced, and it thus becomes possible to distinguish the impacted regions.

One way to reduce illumination on a particular detector is to take measurements with that detector using a laser that has an adjacent FOV to the laser that would be used for a standard TOF measurement. There is some amount of optical power that extends from an adjacent laser into the FOV of the adjacent detector regions due to laser beam divergence and parallax. This optical power provides weak illumination such that the detectors in the blooming region are no longer saturated. The adjacent laser could be from the same laser array, or it could be from a laser array where the FOV of the two laser arrays has been optically interleaved. Measurements with the adjacent laser can be obtained either independently, or simultaneously while scanning is performed for the primary laser. When scanning with the primary laser, data can be obtained for both the detectors within the main FOV of the primary laser as well as adjacent detectors. The LiDAR system performs a comparison of the TOF measurements for each detector obtained with primary and adjacent lasers. Any measurements where the TOF is the same for the two sets of data, a conclusion can be made that the object is “real”.

Any measurements where the TOF is different for the two sets of data, a conclusion can be made that the difference corresponds to the presence of blooming. In areas where blooming is determined, the system can either use the measurement data from an adjacent laser or if the system is recording multiple echoes, the echo from the first set of data corresponding to the region of blooming can be removed from the data set and the system only reports the other echoes. Alternatively, when blooming is determined, the system can report all of the measurement data without eliminating the blooming impact, and instead issue a flag or error that indicates which data is likely impacted by blooming, and the higher-level system can make a decision how to use the data.

In another embodiment of the method, the transmitter power (energized laser optical transmit power) is reduced. In this embodiment, measurements are made with the primary laser, with the optical transmit power from the primary laser reduced to a level such that saturation in the region of interest is not occurring. In this case, the LiDAR system must incorporate a laser driver circuit which can alter the current and/or voltage applied to the lasers. One advantage of using the primary laser compared to the adjacent laser, is a more direct control over the optical power used.

One possible disadvantage of using the primary laser compared to the adjacent laser is that lower power measurements cannot be obtained simultaneously with the higher power (primary) measurements. However, in a system that uses multiple laser pulses to generate an average or histogram, the impact could be minimized by using the lower power for either a few or even a single pulse within the overall set of laser pulses. There would be an impact to SNR, but the impact could be small depending on the system parameters. For instance, if 32 laser pulses were used for an average or histogram measurement, and only 1 of those 32 pulses corresponded to the lower power, the impact on SNR and range would be negligible. Also, the lower power pulse could be implemented for only the region of interest, not the full frame, further mitigating any frame rate and range impacts. This method requires a laser driver that can change laser power (voltage/current) on individual lasers within the array in a short time, sometimes even pulse-to-pulse (<5 μsec). The system will then perform a comparison of the TOF and intensity measurements obtained with the standard operating mode optical power and reduced optical power. Any measurements where the TOF is the same can result in a conclusion that the object is “real”. Any measurements where there are different TOFs can result in a conclusion of the presence of blooming. In areas where blooming is present, the system removes the returns corresponding to the bloomed area and/or reports using a flag or error the data points where blooming is likely occurring.

In yet another embodiment of the method, the optical pulse width is analyzed. LiDAR systems often use pulse width as a simple noise filter. For instance, a pulse width that is as long as the gating time of the TOF measurement would not correspond to any real physical object. Similarly, very small pulse widths can often be distinguished as electronic noise. A simple pulse width noise filter that has a maximum and minimum pulse width is easily implemented. In the case of blooming, pulse width can also be used for a method of determining blooming. A laser pulse that reflects off the object and images back to corresponding centroid location on the detector array will have the maximum optical power density. In this case, the pulse width received by the detector at the corresponding centroid location will be the maximum as the rise time, fall time, and length of the pulse will all be maximized by the received power level. In the region impacted by blooming, the light that is being received will, by definition, be outside the centroid of the received optical signal, and will be lower in optical power, even if the detectors are in saturation. In this case, the rise time and fall time can be expected to be slower, and the length of the pulse should also be reduced. So, by comparing the pulse widths of the pixels that are in the region of blooming, the pixel associated with the true extent of the object will have longer pulse width then those affected by the blooming. However, many factors can impact the pulse width. One feature of the present teaching is that various adaptive algorithm can be implemented to account for these various factors to determine the proper pulse width criteria.

Another embodiment for an adaptive blooming algorithm according to the present teaching makes use of a matrix-addressable or individually addressable transmitter that has the capability to change the FOV being illuminated. One-way blooming can occur is if the transmitter FOV is large enough such that a portion of the laser beam impinges on a highly reflective object. For a laser beam with smaller FOV, smaller divergence will intersect a smaller portion of the scene and so will mitigate the possibility of blooming.

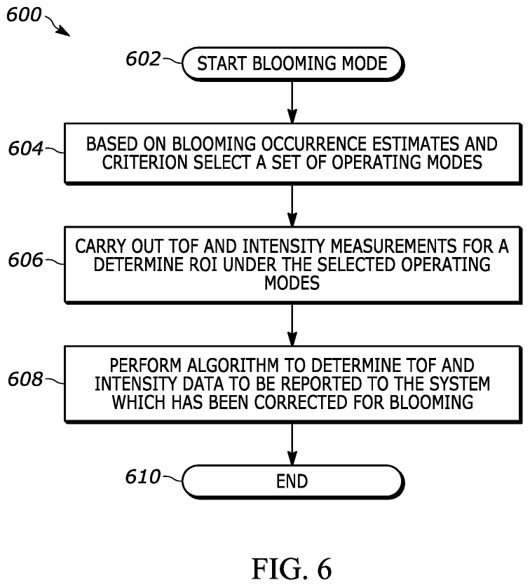

FIG. 6 illustrates a process flow chart 600 for blooming mode for an embodiment of the adaptive LiDAR system of the present teaching. When a blooming mode of operation is initiated 602, the first step 604 is for the system to select a set of operating modes, that can be a set of operating parameters based on the blooming estimate occurrence metrics, and/or the criterion for blooming. Possible operating modes are described herein. In a second step 606, using the selected operating modes/parameters of the first step 604, the system then performs TOF and intensity measurements for a determined region of interest. The determined region of interest in this case could correspond exactly to the region of interest that was used for determining the metrics for occurrence of blooming, or a different region of interest could be chosen corresponding to the selection of the operating modes. Once the measurement data from the selected operating modes has been obtained, the system then uses an algorithm to determine a modified set of TOF and intensity data to be reported to the system in a third step 608, with the expectation that this modified set of data has been corrected in some fashion for the occurrence of blooming. The process flow chart 600 ends at step 610 when the system transitions to a standard operating mode as described herein.

There are engineering tradeoffs in the transmitter FOV versus the detector FOV. One tradeoff is the frame rate and scanning time. Another tradeoff is that a smaller transmitter FOV will slow the frame rate with all other aspects being equal. So, it is not necessarily desirable to always have a small transmitter FOV. One embodiment of the present teaching is to adapt the FOV when blooming is detected and adjust the transmitter FOV either for the full frame, or ideally only for the portion of the FOV affected by the blooming. In the region of blooming in this situation, we would use the TOF and intensity data associated with the smaller transmitter FOV to reduce the blooming.

Another feature of the present teaching is that the LiDAR system can react and adapt to blooming conditions, but some embodiments can also react and adapt to non-blooming conditions via a similar set of analysis steps as described herein. In this situation, instead of adapting the system to make a laser region smaller in response to a blooming condition, if there is no blooming at all in the scene, then the laser region illuminated can be made larger by transitioning from the standard operation to a “no blooming” operating condition.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A method of Light Detection and Ranging (LIDAR), the method comprising:
a) configuring a laser array such that each laser in the laser array generates an optical beam having a laser field-of-view and an intensity that illuminates a region of interest when energized;
b) configuring a detector array such that each detector in the detector array receives light from a detector field-of-view;
c) energizing at least one laser in the laser array;
d) receiving light from the illuminated region of interest of the energized at least one laser in the laser array at the detector array, wherein at least one detector in the array of detectors has a detector field-of-view located within the laser field-of-view of the energized at least one laser in the laser array;
e) processing the received light for select ones of the detectors in the detector array with standard parameters to determine time-of-flight data for the select ones of detectors in the detector array to generate a three-dimensional point cloud representation of an object positioned in the illuminated region of interest of the energized at least one laser in the laser array;
f) analyzing the determined time-of-flight data for the select ones of detectors in the detector array to determine if the processed received light meets a blooming criteria indicating that the three-dimensional point cloud representation of the object is larger than a true three-dimensional point cloud representation of the object;
g) re-energizing the at least one laser in the laser array if the processed received light meets the blooming criteria;
h) receiving light at the detector array from the illuminated region of interest of the re-energized at least one laser in the laser array, wherein at least one detector in the array of detectors has a detector field-of-view located within the laser field-of-view of the re-energized at least one laser in the laser array; and
i) processing the received light for selected ones of the detectors in the detector array with blooming parameters to determine time-of-flight data for the select ones of detectors in the detector array that at least partially compensate for the three-dimensional point cloud representation of the object being larger than the true three-dimensional point cloud representation of the object, thereby generating a more accurate image of the object.

2. The method of claim 1 wherein the processing the received light for select ones of the detectors in the detector array with standard parameters additionally determines intensity data for the select ones of detectors in the detector array to generate the three-dimensional intensity image of an object positioned in the illuminated region of interest of the energized at least one laser in the laser array.

3. The method of claim 2 further comprising analyzing the determined intensity data for the select ones of detectors in the detector array to determine if the processed received light meets the blooming criteria.

4. The method of claim 2 wherein the processing the received light for selected ones of the detectors in the detector array further comprises processing the received light for selected ones of the detectors in the detector array with blooming parameters to determine time-of-flight and intensity data for the select ones of detectors in the detector array that at least partially compensate for the three-dimensional point cloud representation of the object being larger than the true three-dimensional point cloud representation of the object.

5. The method of claim 3 wherein the processing the received light for selected ones of the detectors in the detector array further comprises processing the received light for selected ones of the detectors in the detector array with parameters to determine time-of-flight and intensity data for the select ones of detectors in the detector array that at least partially compensate for the three-dimensional point cloud representation of the object being larger than the true three-dimensional point cloud representation of the object.

6. The method of claim 1 wherein the analyzing the determined time-of-flight data for the select ones of detectors in the detector array to determine if the processed received light meets the blooming criteria comprises comparing time-of-flight data associated with the energized at least one laser.

7. The method of claim 1 wherein the energizing the at least one laser in the laser array comprises energizing a first and second laser in the laser array.

8. The method of claim 7 wherein the first and second lasers are adjacent to each other in the laser array.

9. The method of claim 8 wherein the analyzing the determined time-of-flight data for the select ones of detectors in the detector array to determine if the processed received light meets the blooming criteria comprises comparing time-of-flight data associate with the energized first and second lasers.

10. The method of claim 3 wherein the energizing the at least one laser in the laser array comprises energizing a first and second laser in the laser array.

11. The method of claim 10 wherein the first and second lasers are adjacent to each other in the laser array.

12. The method of claim 11 wherein the analyzing the determined time-of-flight and intensity data for the select ones of detectors in the detector array to determine if the processed received light meets the blooming criteria comprises comparing intensity data associated with the energized first and second lasers.

13. The method of claim 3 wherein the energizing the at least one laser in the laser array comprises energizing the at least one laser in the laser array to generate two different optical transmit powers at two different times.

14. The method of claim 13 wherein the analyzing the determined time-of-flight and intensity data for the select ones of detectors in the detector array to determine if the processed received light meets the blooming criteria comprises comparing the processed and received light at the generated two different optical transmit powers at the two different times.

15. The method of claim 1 wherein the analyzing the determined time-of-flight data for the select ones of detectors in the detector array to determine if the processed received light meets the blooming criteria comprises determining a pulse characteristic of the processed received light.

16. The method of claim 15 wherein the pulse characteristic comprises a pulse width.

17. The method of claim 15 further comprising comparing the determined characteristic of the processed received light to a predetermined pulse characteristic.

18. The method of claim 3 wherein the analyzing the determined time-of-flight and intensity data for the select ones of detectors in the detector array to determine if the processed received light meets the blooming criteria comprises determining a pulse characteristic of the processed received light.

19. The method of claim 18 wherein the pulse characteristic comprises a pulse width.

20. The method of claim 18 further comprising comparing the determined pulse characteristic of the processed received light to a predetermined pulse characteristic.

21. The method of claim 1 wherein the blooming criteria changes as a function of time.

22. The method of claim 1 wherein the blooming criteria changes as a function of ambient light conditions.

23. The method of claim 1 wherein the blooming criteria changes as a function of weather conditions.

24. The method of claim 1 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises reducing a laser field-of-view for at least one of the plurality of lasers in the laser array.

25. The method of claim 3 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises reducing a laser field-of-view for at least one of the plurality of lasers in the laser array.

26. The method of claim 3 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises reducing an optical transmit power generated by at least one laser in the plurality of lasers in the laser array.

27. The method of claim 1 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises reducing a pulse width generated by a laser in the plurality of lasers.

28. The method of claim 3 wherein the processing the received light for selected ones of the detectors in the detector array with the blooming parameters to determine time-of-flight and intensity data for the select ones of detectors in the detector array that at least partially compensate for the three-dimensional point cloud representation of the object being larger than the true three-dimensional point cloud representation of the object comprises reducing a pulse width generated by a laser in the plurality of lasers.

29. The method of claim 1 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises processing received light for detectors corresponding to a detector field-of-view located outside of the laser field-of-view of the energized at least one laser in the laser array.

30. The method of claim 3 wherein the analyzing the determined time-of-flight and intensity data for the select ones of detectors in the detector array comprises comparing the processed received light for detectors corresponding to detector field-of-views located inside of the laser field-of-view of the energized at least one laser in the laser array to the processed received light for detectors corresponding to detector field-of-views located outside of the laser field-of-view of the energized at least one laser in the laser array.

31. The method of claim 30 wherein the processing the received light for selected ones of the detectors in the detector array with the blooming parameters to determine time-of-flight data for the select ones of detectors in the detector array that at least partially compensate for the three-dimensional point cloud representation of the object being larger than the true three-dimensional point cloud representation of the object comprises processing received light for detectors corresponding to a detector field-of-view located outside of the laser field-of-view of the energized at least one laser in the laser array.
